(19) United States
(12) Patent Application Publication
(10) Pub. No.: US 2025/0140866 A1
(43) Pub. Date: May 1, 2025

(54) ANTI-CORROSIVE CURRENT COLLECTOR COATING

(71) Applicant: Medtronic, Inc., Minneapolis, MN (US)

(72) Inventors: Marissa A. Carey, St. Paul, MN (US); Eric I. Hanson, Maple Grove, MN (US); Laura E. McCalla, Brossard (CA)

(21) Appl. No.: 18/926,723

(22) Filed: Oct. 25, 2024

Related U.S. Application Data
(60) Provisional application No. 63/545,798, filed on Oct. 26, 2023.

(51) Int. Cl. H01M 4/62; H01M 4/04; H01M 4/36; H01M 4/66; H01M 10/0525; H01M 10/0568

(52) U.S. Cl. CPC H01M 4/628; H01M 4/0404; H01M 4/0421; H01M 4/0471; H01M 4/366; H01M 4/661; H01M 10/0525; H01M 10/0568; H01M 2300/0025

(57) ABSTRACT

An electrochemical cell includes a positive electrode. The positive electrode includes a first current collector and a first active material. A negative electrode includes a second current collector and a second active material. A separator is disposed between the positive electrode and the negative electrode. A silicon-based anti-corrosion coating is configured to at least partially coat one or both of the first current collector and the second current collector.

### RELATED APPLICATIONS

This application claims the benefit of U.S. Provisional Application Ser. No. 63/545,798, filed Oct. 26, 2023, the entire contents of each of which are incorporated herein by reference.

### TECHNICAL FIELD

This disclosure generally relates to current collectors for batteries. More specifically, this disclosure relates to corrosion resistant current collectors.

### BACKGROUND

For many battery-powered medical tools and devices, the ability to be both cordless and rechargeable is beneficial. For high-powered, high-energy applications, the use of lithium ion battery technology is particularly well suited for battery-powered medical equipment, such as surgical tools. To be safely used in an operating room, the battery-powered surgical tool must be sterile.

### SUMMARY

Examples involve an electrochemical cell comprising a positive electrode. The positive electrode comprises a first current collector and a first active material. A negative electrode comprises a second current collector and a second active material. A separator is disposed between the positive electrode and the negative electrode. A silicon-based anti-corrosion coating is configured to at least partially coat one or both of the first current collector and the second current collector.

A method includes providing an electrochemical cell comprising a positive electrode comprising a first current collector and a negative electrode comprising a second current collector. A silicon-based anti-corrosion coating applied to at least partially coat one or both of the first current collector and the second current collector. The silicon-based anti-corrosion coating is configured to at least partially coat one or both of the first current collector and the second current collector.

The above summary of the present disclosure is not intended to describe each disclosed example or every implementation of the present disclosure. The description that follows more particularly exemplifies illustrative examples. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may be discussed herein, in no event should such discussions serve to limit the claimable subject matter.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1A is a schematic cross sectional view of a battery consistent according to examples described herein.

FIG. 1B is a schematic of an electrode assembly according to examples described herein.

FIG. 2 is a schematic cross sectional view of current collector with a passivation coating according to examples described herein.

FIG. 3 is a flow diagram of a method of making the current collectors with a passivation coating according to examples described herein.

FIG. 4 is a flow diagram of a method of using the batteries according to examples described herein.

### DETAILED DESCRIPTION

Batteries typically have an operating temperature range, and exposure to temperatures outside that range may result in mechanical and/or electrochemical degradation of the battery. For example, lithium ion batteries typically are configured to operate within the temperature range of −20° C. to 60° C. In some battery applications, it is desirable to temporarily subject a battery to a temperature outside of its temperature range. For example, it may be desirable to subject a lithium-ion battery powered medical equipment (e.g., medical device or tool) to temperatures greater than 60° C. to sterilize the equipment while the battery is operably coupled to the equipment. Many hospitals have autoclaves for sterilizing equipment. As such, it would be beneficial to make use of the autoclaves for sterilizing battery-powered surgical tools already having the battery disposed within. In order to achieve this goal, the lithium ion battery must withstand a standard steam autoclave cycle (e.g., 134° C. for 18 minutes) and maintain usability at application temperature (e.g., 10° C. to 45° C.) for 100 to 300 autoclave cycles. Thus, batteries, such as lithium ion batteries, are needed that can withstand high temperature conditions while maintaining their power output. Such batteries may be used in a variety of diagnostic tools, medical devices, medical equipment, and hand-held surgical tools that are commonly sterilized prior to use. Examples of such devices and tools include ultrasonic dissectors, vessel sealing devices, staplers, orthopedic saws and drills, radiofrequency powered surgical sealing devices, nerve integrity monitoring devices, ablation devices, powered atherectomy devices, pumps, implantable medical devices, wearable medical devices, and the like. In addition to medical equipment, batteries may be exposed to high temperatures in other applications. For example, batteries in equipment used for deep drilling operations may be exposed to temperatures up to 180° C. Besides special battery applications, consumer products having batteries may be intentionally or inadvertently exposed to high temperatures, for example, being left in a vehicle on a hot day. These exposures to extreme temperature may impact the performance of the battery. While examples described herein involve batteries that can withstand high temperature environments, it is to be understood that the batteries described herein may be used in any environment. For example, the batteries described herein may be used in devices that are not subjected to an autoclave process.

Current collector corrosion in batteries may impact the performance of the battery. For example, corrosion of the current collector may lead to a loss in battery capacity and/or loss of the mechanical integrity of the current collector. When used in reference to a current collector, the term “corrosion” refers to the degradation of a current collector through the dissolution of the material making up the current collector resulting in reduction in the mass of the current collector. In reference to a battery, a current collector is an electrical bridge that allows for the transport of electrons to and from an external circuit (e.g., the device/tool to which the battery is operably coupled). As such, current collectors are made of conductive material, such as metals (e.g., aluminum, copper, titanium, and the like). Degradation of the current collector through corrosion results in a loss of conductive material mass which may impact battery performance. By-products of corrosion may also contribute to internal shorts in the battery. Corrosion may occur during battery manufacturing (e.g., the loading of cathode active material onto a current collector), during battery discharging, during battery charging, when the battery is electrochemically inactive, or combinations thereof. Corrosion may occur over the lifetime of a battery and ultimately manifest as pitting corrosion, crevice corrosion, stress corrosion cracking, and the like.

The mechanisms through which battery current collector corrosion occurs are complex and not entirely known. The mechanisms of corrosion depend on the current collector composition, electrolyte composition, operating voltage of the battery, temperatures to which the battery is exposed, manufacturing conditions, and the like. It is thought that current collector corrosion may be caused by reactions (e.g., electrochemical reactions) between the current collector and other battery components such as the electrolyte solvent, the electrolyte salts, the cathode active materials, degradation products thereof, ions thereof, radicals thereof, or combinations thereof. One proposed mechanism involves the attack of current collector material and/or oxidized current collector material by acidic species which promotes the corrosion of the current collector. Another proposed mechanism involves the electrochemical oxidation of electrolyte solvent molecules to form solvent radical cations. The radical cations can then undergo deprotonation to release protons which can then promote the dissolution of the material that makes up of the current collector. For example, in a lithium ion battery that includes an aluminum cathode current collector, oxidation of electrolyte solvent molecules may promote dissolution of Al³⁺ and/or other aluminum containing compounds.

Examples described herein may have a passivation coating or layer that prevents and/or reduces corrosion of the current collector. The passivation coating may be referred to herein as a passivation coating or an anticorrosion coating, for example. Passivation is the process by which a base metal (e.g., a metal) acquires a protective surface layer that prevents and/or reduces the base metals susceptibility to corrosion. A passivation coating may be formed through the chemical reaction of the base metal with a compound, an ion thereof, or a radical thereof. In some examples, the passivation coating may not be the result of a chemical reaction. For example, the passivation coating may be a conformal protective coating.

In some batteries the electrolyte includes a halide containing salt that can react with the current collector material to form a current collector material-halide reaction product that acts as a passivation group. For example, in many lithium ion batteries, a large fraction of the salt included in an electrolyte is lithium hexafluorophosphate (LiPF₆), a salt know to suppress the corrosion of Al foil current collectors through the creation of a passivation coating. Generally, in such batteries, the LiPF₆ can react with the aluminum and/or the aluminum oxide of the current collector to ultimately form a passivation coating that includes a plurality of AlF₃ passivation groups. In such lithium ion batteries, it is thought that two passivation layers exist; i) the Al₂O₃ layer and ii) a AlF₃ containing layer. The AlF₃ containing layer is the outermost layer and as such, the formation of the AlF₃ containing layer includes the reaction products of the LiPF₆ salt with the Al₂O₃ layer.

The most commonly used passivating salt LiPF₆ is generally not thermally stable and therefore may not function in its passivating capacity when used in batteries that are exposed to high temperatures. For example, LiPF₆ degrades around 80° C. (e.g., to form insoluble LiF and PF₅ decomposition products as well as HF) which may prevent the formation of the passivation coating and/or increase the rate of current collector corrosion. As such, batteries that will be exposed to high temperatures are often manufactured with low (if any) LiPF₆. Without protection from a passivating salt, current collectors often have severe corrosion and performance loss. The use of other common halogen containing electrolyte salts in high temperature application lithium ion batteries may result in unstable current collectors. In some such batteries, a material-halide passivation coating (e.g., AlF₃) does not completely form, leaving the current collector highly vulnerable to corrosion.

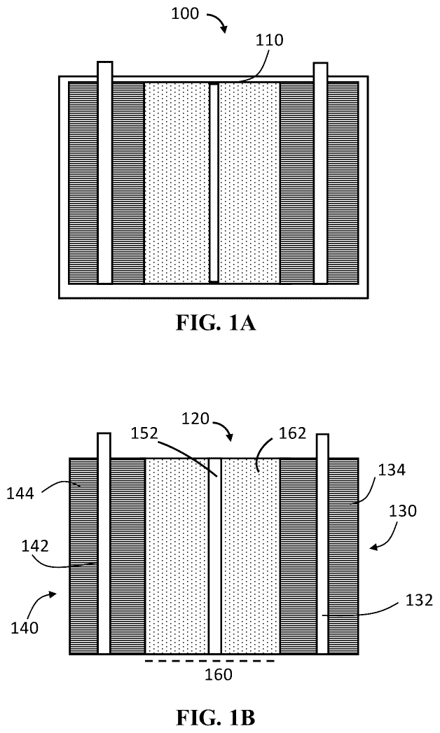

The present disclosure describes batteries that include a current collector of the present disclosure. FIG. 1A depicts the cross section of a battery. Although not shown, the current collectors of the present disclosure may be used in a prismatic battery configuration, a button/coin battery configuration, and a pouch battery configuration. In some examples, the battery 100 is a lithium ion battery.

The battery 100 includes a housing 110. The housing 110 serves to contain the contents of the cell. Although not shown, in some examples, the housing 110 may be a conductive housing, that is, a housing at a non-neutral polarity. In such examples, the housing 110 is electrically conductive and may serve as an electrode or a current collector to complete the circuit of the battery. In some examples, the interior surface (the surface in contact with the electrode assembly), or a portion of the interior surface, of the housing may be coated with an insulative material. Coating at least a portion of the internal surface of the housing 110 with an insulative material may function to decrease and/or decrease the likelihood of housing corrosion and/or unwanted plating on the housing.

FIG. 1B is a cross-sectional view of the electrode assembly 120 of the battery 100 of FIG. 1A. The electrode assembly 100 includes an anode 130, a cathode 140, a separator 150, and an electrolyte 160.

The electrode assembly 120 of the battery 100 includes a cathode 140. The cathode 140 is generally configured as the positive electrode. The cathode 140 includes a cathode current collector 142. The cathode current collector 142 may be of the current collectors (e.g., corrosion resistant current collectors) as described herein.

In some examples, the cathode 140 includes a cathode active material 38. The cathode active material 38 is the material that participates in the reduction reaction. In some examples the cathode active material includes a lithium-containing metal oxide, a lithium-containing metal phosphate, or both. Examples of lithium-containing metal oxides include lithium cobalt oxide (e.g., LiCoO₂), lithium magnesium oxide (e.g., LiMn₂O₄), lithium nickel manganese cobalt oxide (e.g., Li(NiMnCo)O₂), lithium nickel oxide (e.g., LiNiO₂), lithium nickel cobalt aluminum oxide (e.g., Li(NiCoAl)O₂), and combinations thereof. Examples of lithium-containing metal phosphates include lithium iron phosphate (e.g., LiFePO₄), lithium iron cobalt phosphate (LiFeₓCo₍₁₋ₓ₎PO₄; x=0, 0.2, 0.5, 0.8, or 1), lithium manganese iron phosphate (LiMnFePO₄) or combinations thereof.

In some examples, at least a portion of the cathode active material 36 is surface treated. In some examples, the cathode active material surface treatment includes a metal oxide (e.g., Al₂O₃), a metal phosphate (e.g., LaPO₄), a metal halide, carbon, or a combination thereof. In some examples, the cathode active material surface treatment includes a positive temperature coefficient material. In some examples, the cathode active material is a lithium-containing metal oxide that is surface treated. According to some examples, the cathode active material may be doped instead of or in addition to being surface treated.

In some examples, the cathode 140 includes one or more additional cathode additives. In some such examples, the one or more cathode additives includes a positive temperature coefficient material.

In some examples, the cathode 140 includes a conductive carbon additive. The conductive carbon additive is electrically conductive and may serve to enhance the electrochemical performance of the cathode 140 and/or the cathode active material 38. Examples of conductive carbon additives include natural graphite, artificial graphite (e.g., mesocarbon microbead), graphene, carbon nanotubes, carbon black, and combinations thereof.

In some examples, the cathode 140 includes a cathode binder. The cathode binder allows for the physical connection and/or electrical connection of two or more parts of the cathode (e.g., cathode current collector, cathode active material, any cathode additives). Any suitable anode binder may be used. Examples of suitable cathode binders include carboxy methyl cellulose (CMC), styrene-butadiene rubber (SBR), polyvinylidene fluoride (PVDF), polytetrafluoroethylene (PTFE), or combinations thereof. In certain examples, the anode binder includes PVDF.

The anode 130 is generally configured as a negative electrode. The anode 130 includes an anode current collector 132. In some examples, the anode current collector 132 may be any current collector as described herein. In other examples, the anode current collector may be any suitable anode current collector material. Non-limiting examples of anode current collector materials include copper, aluminum, titanium, carbon, and combinations thereof. Although not depicted in FIG. 1A, in some examples the housing 110 is at least partially conductive and at a negative polarity and serves as the anode current collector 132. The anode current collector 132 may be of any suitable configuration. Examples of suitable anode current collector configurations include a foil, a mesh, a foam, an etched surface, or combinations thereof. In some examples, the anode current collector is a copper foil.

In some examples, at least a portion of the anode current collector 132 is surface treated (e.g., coated). Non-limiting examples of surface treatments include carbon coatings; copper coatings; nitride coatings; oxide coatings that include copper, aluminum, titanium, carbon, or combinations thereof; or any combination thereof. In some examples, at least a portion of the anode current collector 132 is surface treated with a positive temperature coefficient material. A positive temperature coefficient material is a material that has an increase in electrical resistance when exposed to increased temperatures. In some examples, a positive temperature coefficient material includes a mixture of carbon black and a polymer (e.g., polypropylene).

The anode 130 includes an anode active material 134. The anode active material 134 is in electrical contact (directly and/or through a conductive material such as a conductive compound) with at least a portion of the anode current collector 132.

In some examples the anode active material 134 includes lithium. The lithium may be in the form of metallic lithium; a carbon-containing material capable of intercalating lithium such as graphite; a metal-alloy containing material capable of intercalating lithium such as lithium titanate (e.g., Li₄Ti₅O₁₂); lithium alloys such as lithium-aluminum, lithium-silicon, lithium-bismuth, lithium-cadmium, lithium-magnesium, lithium-tin, lithium-antimony, lithium-germanium, lithium-lead; oxides thereof; sulfides thereof; phosphides thereof; carbides thereof; nitrides thereof; and combinations thereof.

The anode active material 134 may include lithium titanium oxide. In some examples, the lithium titanium oxide includes a compound of the general formula Li₄MₓTi₅₋ₓO₁₂; where M is a metal selected from aluminum, magnesium, nickel, cobalt, iron, manganese, vanadium, copper, chromium, molybdenum, niobium, tungsten, or combinations thereof; and 0≤x≤1. In some examples, the lithium titanium oxide includes Li₂Ti₃O₇; Li₄Ti_{4.75}V_{0.25}O₁₂; Li₄Ti_{4.75}Fc_{0.25}O_{11.88}; Li₄Ti_{4.5}Mn_{0.5}O₁; or combinations thereof. In some examples, the lithium titanium oxide includes a compound of the general formula LiM′M″XO₄; where M′ is a metal selected from nickel, cobalt, iron, manganese, vanadium, copper, chromium, molybdenum, niobium, or combinations thereof; M″ is a three valent non-transition metal; and X is a metal selected from zirconium, titanium, or a combination thereof.

In some examples, the lithium titanium oxide includes a lithium titanate. Lithium titanates are compounds consisting of lithium, titanium, and oxygen. In some examples, the lithium titanium oxide includes a lithium titanate of the general formula LiₓTi_{y}O₄; where x is 0≤x≤4; and y is 0≤y≤2. In some examples, the lithium titanate is used in any state of lithiation, for example, a compound of the general formula Li₄₊ₓTi₅O₁₂; where 0<x<3. In some examples the lithium titanate is Li₂TiO₃; Li₄Ti₅O₁₂ (also called Li₁₊ₓ[Li_{1/3}Ti_{5/3}])₄ where 0≤x<1); Li₄TiO₄; or combinations thereof.

According to some examples, the anode active material 134 may include a niobium metal oxide. For example, the niobium metal oxide may be Nb₁₄W₃O₄₄, Nb₁₆W₅O₅₅, Nb₁₈W₈O₆₉, Nb₂ WO₈, Nb₁₈W₁₆O₉₃, Nb₂₂W₂₀O₁₁₅, Nb₂Mo₃O₁₄, Nb₁₄Mo₃O₄₄, Nb₁₂MoO₄₄, or any combination thereof.

The anode active material 134 may include a carbon-containing material capable of intercalating lithium. Examples of carbon-containing materials capable of intercalating lithium include natural graphite, artificial graphite (e.g., mesocarbon microbead), graphene, carbon nanotubes, carbon black, and combinations thereof.

In some examples, the anode active material includes a polymer.

The anode active material 134 may include a metal-alloy containing material capable of intercalating lithium. Examples of metal-alloy containing materials capable of intercalating lithium include silicon-containing materials and tin-containing materials.

The anode 130 may include one or more additional anode additives. In some such examples, the anode additive includes a positive temperature coefficient material.

In some examples, the anode 130 includes a conductive carbon additive. The conductive carbon additive does not intercalate lithium. The conductive carbon additive is electrically conductive. The conductive carbon additive may enhance the electrochemical performance of the anode 130 and/or the anode active material 134. Examples of conductive carbon additives include natural graphite, artificial graphite (e.g., mesocarbon microbead), graphene, carbon nanotubes, carbon black, and combinations thereof.

The anode 130 may include an anode binder. The anode binder allows for the physical connection and/or electrical connection of one or more components (e.g., anode active material, anode current collector, anode additives) of the anode 130. Any suitable binder may be used such as those described relative to the cathode binder.

The electrode assembly 120 of the battery 100 includes a separator 152. The separator 152 is generally configured to inhibit direct interaction between the cathode 140 and the anode 130, thus limiting the likelihood of internal short circuits. The separator is also generally configured to allow for the transport of ions between the cathode 140 and the anode 130. The separator 152 is located in the interelectrode region 160. The interelectrode region 160 is the entire volume of the cell not occupied by the cathode 140 or the anode 130. The interelectrode region 160 includes any pores within the cathode 140 and/or the anode 130. Although not depicted, in some examples, the separator 152 may be in physical contact with one or both of the electrodes.

To allow for the transport of ions between the anode 130 and the cathode 140, the separator 152 is generally porous. At least some of the pores of the separator 152 are permeable, that is, they allow the ions to flow from one side of the separator 152 to the other side of the separator 152.

The separators included in the batteries of the present disclosure are designed to withstand multiple exposures to temperatures of greater than 100° C. with little to no degradation. Not wishing to be bound by theory, it is thought that the separator may not need to include a material that has a melting temperature equal to or greater than the highest temperature that the battery is intended to be exposed to. It is thought that although the battery is exposed to such temperatures, the separator within the battery may be at least partially insulated and as such, reach a lower temperature than the exposure temperature.

In some examples, the separator includes two or more layers. The two or more layers may or may not be bound together (e.g., laminated), to from a single multi-layer composite separator. Each layer of a composite separator may have the same melting temperature, each a layer of the composite separator may have different melting temperature, or two or more of the layers of the separator may have the same melting temperature while one or more other layers have different melting temperatures.

In some examples, the separator 152 includes one or more layers that have a melting temperature or mechanical degradation temperature of 100° C. or greater, preferably 125° C. or greater. In some examples, the separator includes one or more layers that have a melting temperature or mechanical degradation temperature of 100° C. or greater, 125° C. or greater, 135° C. or greater, 150° C. or greater, 160° C. or greater, 170° C. or greater, 180° C. or greater, or 200° C. or greater. There is no desired upper limit to the melting temperature or mechanical degradation temperature of a layer included in a separator; however, in practice the separator includes one or more layers having melting temperature or mechanical degradation temperature of 300° C. or less. In some examples, the separator includes one or more materials having melting temperature or mechanical degradation temperature of 100° C. to 300° C., 125° C. to 300° C., 150° C. to 300° C., or 180° C. to 300° C.

In certain examples, multiple separator layers may be used, each of which has melting temperature or mechanical degradation temperature greater than 100° C. or greater than 125° C. In some examples, one or more of the layers of a composite separator may have a lower melting temperature or mechanical degradation temperature such that it melts or mechanically decomposes when exposed to an elevated temperature. Such a layer sandwiched between two or more layers that have melting temperature or mechanical degradation temperature above the elevated exposure temperature may serve the purpose of a shutdown separator. For example, a composite separator may include three layers. The inner layer may have a melting temperature or mechanical degradation temperature that is lower than the anticipated elevated temperature that the battery and/or separator will be exposed to. The two outer layers may have melting temperature or mechanical degradation temperature that are greater than the anticipated elevated temperature that the battery and/or separator will be exposed to. Upon exposure of the battery to an elevated temperature, the inner layer of the composite separator may melt or mechanically decompose, preventing ion flow in the battery while maintaining the separation between the anode and the cathode. An example of such a composite separator configuration includes a separator that has an inner layer material with a melting temperature or mechanical degradation temperature of approximately 130° C. and two outer layers having a melting temperature 200° C. or greater. Such separators may include a polyethylene inner layer and polypropylene outer layers such as the separators available from CELGARD (Charlotte, NC) under the trade name CELGARD TRILAYER PP/PE/PP.

The separator 152 may include any suitable separator material. Examples of suitable separator materials include, polymeric porous membranes such as polyethylene, polypropylene, polyterephthalate, polyimide, cellulose based polymers and combinations thereof; ceramic coated polymeric porous membranes (e.g., ceramic coated polypropylene, ceramic coated polyethylene, or both); modified polymeric membranes with thin oxide coatings of titania (TiO₂), zinc oxide (ZnO), silica (SiO₂), and combinations thereof; and hybrid organic-organic assemblies such as those that contain SiO₂ nanoparticles covalently tethered within a polymeric network such as polyurethanes, polyacrylates, polyethylene glycol; and combinations thereof.

In some examples, the separator material is a material that has a melting temperature mechanical degradation temperature of 125° C. or greater. Examples of such materials include polyimides, polyolefins (e.g., polypropylene), polyethylene terephthalate, ceramic-coated polyolefin, cellulose, or combinations thereof. Such materials may be in the form in microfibers, nanofibers, or both. In some examples, the separator includes a combination of microfibers and nanofibers. In some examples, the separator includes polyethylene terephthalate microfibers and cellulose nanofibers. Examples of such separators are disclosed in U.S. Pat. No. 8,936,878 and are available from Dreamweaver International (in Greer, SC) under the tradename SILVER, GOLD, and TITANIUM.

Examples of separator materials that have a melting temperature of 200° C. or greater include polyimide, polyethylene terephthalate, cellulose, aramid fibers, ceramics, and combinations thereof.

In some examples, the separator may be surface treated. In some examples, one or more layers of a composite separator may be surface treated. Example surface treatments include carminic treatments such as aluminum oxides and silicon oxides (SiOX).

The electrode assembly 120 of the battery 100 includes an electrolyte 162. The electrolyte 162 may occupy any or all of the interelectrode region 160. The electrolyte 162 physically contacts the anode 130, the cathode 140, and the separator 152. The electrolyte is a homogenous solution that includes at least one salt and a solvent.

In some examples, the electrolyte includes one or more additional salts. In some examples, the one or more additional salts are employed at concentrations below their respective saturation points at the application temperature. As such, the salts are dissolved into their component ions and are a part of the electrolyte. In a lithium-ion battery, at least one of the salts includes lithium.

In some examples, the electrolyte includes at least one halogen containing salt. In such examples, the halogen containing salt may contribute to the formation of the one or more passivation regions as discussed elsewhere herein. In some examples, the electrolyte may include a halogen containing salt, a lithium and halogen containing salt, a lithium salt that does not include a halogen, or combinations thereof. In some examples the halogen containing salt a fluorine containing salt. In some examples the halogen containing salt a chlorine containing salt. In some examples, the fluorine contains salt and also includes lithium. In some examples, the halogen containing salt does not include lithium.

Examples of fluorine and lithium containing salts include lithium bis(trifluoromethanesulfonimide) (LiTFSI); lithium difluoro(oxalato)borate (LiDFOB); lithium bis(pentafluoroethyl sulfonyl)imide (LiBETI); lithium bis(fluorosulfonyl)imide (LiFSI); lithium tetrafluoroborate (LiBF₄); bis(perfluorocthanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dicyano-pentafluoroethyl-imidazole; and combinations thereof.

Examples of chlorine and lithium containing salts include lithium perchlorate.

Examples of lithium salts that do not include a halogen include lithium bis(oxalato) borate (LiBOB); lithium tetracyanoborates (Bison); lithium dicyanotriazlate (DCTA).

The battery has a total amount of salt. The total amount of salt is the sum of the sum of all salts included in the electrolyte. The molar quantity of the total amount salt is based on the volume of the electrolyte. In some examples, the electrolyte has a total amount of salt that is 0.01 M or greater, 0.5 M or greater, 1 M or greater, 2 M or greater, 3 M or greater, 4 M or greater, or 5 M or greater. In some examples, the electrolyte has a total amount of salt that is 6 M or less, 5 M or less, 3 M or less, 2 M or less, 1 M or less, or 0.5 M or less. In some examples, the electrolyte has a total amount of salts that is 0.01 M to 6 M, 0.01 M to 5 M, 0.01 M to 4 M, 0.01 M to 3 M, 0.01 M to 2 M, 0.01 M to 1 M, or 0.01 M to 0.5 M. In some examples, the electrolyte has a total amount of salt that is 0.5 M to 6 M, 0.5 M to 5 M, 0.5 M to 4 M, 0.5 M to 3 M, 0.5 M to 2 M, or 0.5 M to 1 M. In some examples, the electrolyte has a total amount of salt that is 1 M to 6 M, 1 M to 5 M, 1 M to 4 M, 1 M to 3 M, or 1 M to 2 M. In some examples, the electrolyte has a total amount of salt that is 2 M to 6 M, 2 M to 5 M, 2 M to 4 M, or 2 M to 3 M. In some examples, the electrolyte has a total amount of salt that is 3 M to 6 M, 3 M to 5 M, or 3 M to 4 M. In some examples, the electrolyte has a total amount of salt that is 4 M to 6 M or 4 M to 5 M. In some examples, the electrolyte has a total amount of salt that is 5 M to 6 M.

Generally, the use of LiPF₆ alone in an electrolyte may result in rapid mechanical and/or electrochemical degradation of the battery when exposed to elevated temperatures. In some examples, the battery includes 25 mol-% or less of LiPF₆ of the total salt amount, if any. In some examples, the battery has a total salt amount that includes 25 mol-% or less, 15 mol-% or less, 10 mol-% or less, 5 mol-% or less, 1 mol-% or less, if any, of LiPF₆. In some examples, the battery has a total salt amount that includes 1 mol-% to 5 mol-%, 1 mol-% to 10 mol-%, 1 mol-% to 15 mol-%, 1 mol-% to 25 mol-%, 5 mol-% to 10 mol-%, or 5 mol-% to 15 mol-% of LiPF₆, if any.

In some examples, the electrolyte 162 is a liquid electrolyte. A liquid electrolyte includes a solvent and at least one salt. In some examples the solvent is an organic solvent. Examples of suitable organic solvents include linear carbonates such as ethylmethyl carbonate (EMC), ethylene carbonate (EC), dimethyl carbonate (DMC), diethyl carbonate (DEC); ethers such as 1,2,-diethoxyethane (DME); linear carboxylic esters such as methyl formate, methyl acetate, and methyl propionate; nitriles such as acetonitrile; cyclic carbonates such as butylene carbonate (BuC), phenylene carbonate (PeC), hexylene carbonate (HeC), octylene carbonate (OcC), and dodecylene carbonate (DoC); organo sulfur compounds such as sulfolane; and combinations thereof.

Organic solvents that have high boiling points tend to have increased viscosities which may result in lower ionic conductivity. As such, in some examples, the organic solvent of the electrolyte includes at least one solvent having a boiling point below 140 C. Examples of such solvents include some linear carbonates such as 1,2-diethyoxyethane; some linear carboxylic esters such as methyl formate, methyl acetate, ethyl acetate, and methyl propionate; and some nitriles such as acetonitrile.

In certain examples, the organic solvent includes a mixture of ethylene carbonate (EC) and ethylmethyl carbonate (EMC). In certain examples, the organic solvent includes a mixture EC and EMC in a range of 10:90 to 50:50 by weight. In certain examples, the organic solvent includes a mixture of EC and EMC in a weight ratio of 30:70.

In certain examples, the organic solvent includes a mixture of EC, EMC, and sulfolane (SL). In certain examples, the organic solvent includes a mixture of EC, EMC, and SL in a weight ratio of 20:10:70.

In some examples, the electrolyte includes one or more electrolyte additives. Typically, an electrolyte additive enables a higher voltage operation (e.g., greater than 4.2 V), but can also be used at lower voltages (e.g., less than 4.2 V) and at elevated temperatures (e.g., temperatures greater than 100° C.). The electrolyte additives may include unsaturated compounds such as vinylene carbonate (VC) or vinyl ethylene carbonate (VEC); a sulfur-containing compound such as 1,3-propane sultone (PS), prop-e-ene 1,3-sultone (PES), 1,3,2-dioxthiolane-2-2dioxide (DTD), trimethylene sulfate (TMS), methylene methyl disulfonate (MMDS); boron-containing compounds such as trimethylboroxine and trimethoxyboroxine (TMOBX); phosphorous-containing compounds such as tris (1,1,1,3,3,3-hexafluoro-2-isopropyl) phosphate (HFiP), tris (trimethylsilyl) phosphate (TTSP), tris (trimethylsilyl) phosphite (TTSPi), triallyl phosphate (TAP); aromatic compounds such as biphenyl (BP); heterocyclic compounds such as thiophene (TP); Lewis acid-base adducts such as pyridine-boron trifluoride (PBF); 2,4,6,8-tetramethyl-2,4,6,8-tetravinylcyclotetra-siloxane (ViD4); and mixtures thereof.

In some examples, the electrolyte 162 is a gel electrolyte. A gel electrolyte includes a polymer network that immobilizes a liquid electrolyte containing a solvent and one or more salts where one of the one or more salts is LiBOB. The solvent may be any organic solvent described elsewhere herein. The one or more salts may be any salt or combination of salts described elsewhere herein. The polymer network may include one or more polymers. Examples of suitable polymers include poly(ethylene oxide) and copolymers such as poly(ethylene-propylene oxide); polymers based on the acrylic group such as poly(methyl methacrylate), poly(acrylic acid), lithium poly(acrylate), poly(ethylene glycol diacrylate), and combinations thereof; polymers based on the vinylidene fluoride group such as poly (vinylidene fluoride) (PVdF), copolymers such as poly (vinylidene fluoride-hexafluoropropylene) (PVdF-HFP), and combinations thereof; and combinations thereof.

In some examples, when employed in a battery that is subjected to elevated temperatures, for example in a range of about 100° C. to about 200° C. or in a range of about 100° C. to about 170° C., at least one current collector is corrosion resistant. In some examples, the at least one corrosion resistant current collector is the current collector as described herein. The current collector may display any level of corrosion, or lack thereof, after exposure to a given set of conditions as described elsewhere herein.

In some examples, the batteries of the current collect maintain at least a portion of their capacity after exposure to a given set of conditions. The amount of retention of capacity may be any amount after exposure to a given set of conditions as described elsewhere herein.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

The electrolyte and/or additives in lithium ion and similar batteries oxidize the aluminum current collector. This oxidation may eventually compromise the battery and may ultimately cause the electrode to disintegrate and the battery to fail. Examples described herein involve using a unique passivating (barrier) coating on the aluminum electrode to prevent or substantially reduce the aluminum from oxidizing (corroding). Examples described herein use a silicon-based coating. For example, the coating may include hexamethyldisilane (HMDS) or a Spin on Glass (e.g., silicon dioxide) to create a barrier to corrosion on the aluminum current collector surface. The barrier prevents the corrosion while still allowing electrical conduction through the coating. The result is a stable aluminum current collector that does not degrade or degrades at an extremely slow rate compared to the current battery designs. Preventing corrosion of the current collector greatly improves the battery reliability and extends the battery life and thus increases safety of the battery. The silicon-based passivation coating may provide a crack-resistant protective layer. Silicon-based coatings and/or passivation layers may be more crack resistant as opposed to other types of passivating layers such as carbon-based passivation layers and AlF-based passivation layers.

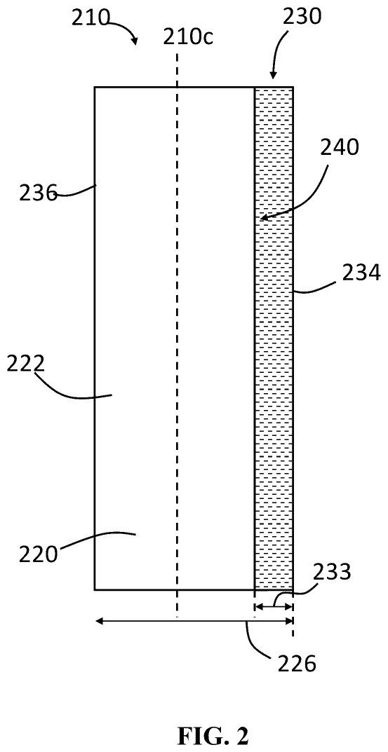

FIG. 2 is a cross sectional view of a schematic of a current collector having a passivation coating according to examples described herein. The current collector 210 includes a bulk material 220 and a surface 234. The bulk material includes a base metal 222 and a passivation coating 230. The passivation coating 230 forms the surface 234 of the bulk material.

The bulk material 220 defines the configuration of the current collector. The current collector may be of any suitable configuration such as a foil, mesh (e.g., a knitted, woven, or expanded mesh), or a foam. FIG. 2 depicts a current collector 210 having a bulk material 220 with a foil configuration. A foil current collector has a sheet-like configuration and is often formed by rolling sheets of a metal into thinner sheets. In a mesh configuration, the bulk material is in a gride-like configuration that includes a plurality of transport pores that are randomly or evenly spaced. Transport pores are pores that have at least two pore openings and each porc opening is coupled to a surface exposing the pore to the surrounding environment. The mesh current collector may be made by weaving and/or knitting a plurality of wires together. In a foam, the bulk material is porous and includes transport pores and open pores. An open pore is a pore that has at least one pore opening that is coupled to a surface thereby exposing the pore to the surrounding environment. A foam configuration may be made for example, by the powder metallurgy foaming method, melt foaming method (e.g., direct blowing method or foaming agent foaming method), or the secondary foaming method.

The bulk material 220 defines at least one surface 234. When used in reference to the bulk material 220, a “surface” is a portion of the bulk material 220 that is directly exposed to the surrounding environment. The current collector configuration determines how many surfaces the bulk material has. For example, the current collector shown in FIG. 2 is a cross sectional view of a foil configuration in which the bulk material has a total of 6 surfaces (e.g., the facets of the foil) of which four are shown and one is labeled (e.g., surface 34). Other current collector configurations may have a different number of surfaces. Porous current collectors (e.g., a mesh or a foam), include a plurality of pores coupled to the surface, each pore having a pore surface. The pore surfaces are surfaces in that they are directly exposed to the surrounding environment. The surfaces of the bulk material 220 can have topography that is constant or that varies in the x, y, and/or z directions. For example, each one of the surfaces of the bulk material 220 can be smooth or rough. The bulk material 220 may have a single continuous surface, such as, for example, a spherical or ovoid configuration. The bulk material 220 may have multiple surfaces, for example, a polyhedron.

The bulk material 220 includes a base metal 222. The base metal 222 is the most abundant material of the bulk material 220 (e.g., greater than 50 wt-% of the bulk material). The base metal 222 may be any electrically conductive material (i.e., a material capable of conducting the flow of charge carriers such as electrons). The base metal 222 may be a metal such as transition metal (Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Dg, Bh, Hs) or a post-transition metal (Al, Ga, Zn, Cd, In, Sn, Hg, Ti, Pb, Bi, Po). In some examples, the base metal may be an alkali earth metal such as Mg. Specific examples of electrically conductive materials that are suitable for a current collector base metal 222 include copper (Cu), nickel (Ni), titanium (Ti), aluminum (Al), stainless steel, carbonaceous materials, and combinations thereof. In some examples, the base metal 222 is Al. In some examples, the base metal 222 is Ti. In some examples, the base metal 222 is Mg.

According to some examples, the base metal 222 is doped with a metal dopant, for example. The dopant may be any metal (e.g., an alkaline earth metal (Be, Mg, Ca, Sr, Ba, Ra); a transition metal; or a post-transition metal (e.g., Al)). In some examples, the dopant includes an alkaline earth metal. In some examples, the dopant includes a post transition metal. In some examples, the dopant is an alloy. In some examples, the dopant includes magnesium. In some examples, the dopant includes aluminum. In some examples, the base metal 222 is aluminum, and the dopant includes magnesium. In such examples, the current collector is an Al—Mg alloy.

In some examples, at least a portion of the current collector is surface treated (e.g., coated) with a passivation coating 230. In some examples, the current collector surface treatment includes a silicon-based compound.

The passivation coating 230 forms at least a portion of one surface 234 (or a portion of a surface) of the bulk material 220. The passivation coating 230 functions to prevent and/or decrease the likelihood of current collector corrosion (e.g., corrosion of the bulk material). The bulk material may include multiple passivation coatings or layers that form multiple surfaces. The bulk material may include a passivation coating or multiple passivation layers that define a portion or portions of a surface. The passivation coating 230 adheres with the base metal (e.g., the base metal and/or the metal dopant) with various chemical species. As such the passivation coating 230 forms an interface 240 with the base metal 222. The passivation coating 230 extends from the interface 240 to the surface 232 of which it forms. In an example, the passivation coating is applied as a solution in a solvent. Once applied, the solvent is baked off in the process. In examples in which the passivation coating contains multiple layers, each layer may be formed separately by coating and heating each time, some cross-linking may occur between the layers of the passivation coating during the baking steps.

According to various examples, the silicon-based anti-corrosion coating includes a silane compound. For example, the silane compound may include a mixture of molecules with a functional silane group on one end. The silicon-based anti-corrosion compound comprises one or more of APTES ((3-Aminopropyl) triethoxysilane), HMDS (e.g., trimethylsilyl), GPTMS ((3-Glycidyloxypropyl) trimethoxysilane), and an SiO₂ doped mixture suspended in a solvent (for example, spin-on-glass).

The passivation coating 230 includes at least one passivation group. In some examples, the passivation coating 230 includes a plurality of passivation groups. In some examples, the passivation groups include silane conformal coatings that are not chemically bonded to the base metal (except for Van der Waals forces, for example). Each passivation group may be the reaction product of a component of a current collector with a component of the surrounding environment. Such reactions may be termed passivation reactions. For example, a passivation group may be the passivation reaction product formed between the base metal and a salt, oxygen, or both. Passivation groups may also be formed as the reaction product of an already formed passivation group with a chemical species in the surrounding environment. In some examples, the passivation coating may include a plurality of passivation groups that include metal dopant-halide passivation groups, base metal-halide passivation groups, metal dopant-oxide passivation groups, base metal-oxide passivation groups, silicon containing passivation groups, or combinations thereof.

In some examples, the passivation coating 230 may form a continuous layer such as shown in FIG. 2. In such examples, the passivation coating 230 forms an entire surface of the bulk material. In other examples, the passivation coating 230 may be discontinuous (i.e., the bulk material includes two or more passivating regions). In such examples, the passivation coating 230 forms a portion of a surface of the bulk material. In some examples, the passivation coating 230 may be discontinuous at one point in time but form a continuous layer over at least a portion of the surface of the current collector.

According to various examples, the bulk material 220 has a thickness 226. The thickness is the average width of the bulk material (e.g., a foil) in its narrowest dimension. In some examples, the thickness may be 5 μm or greater, 10 μm or greater, 12 μm or greater, 14 μm or greater, 16 μm or greater, 18 μm or greater 20 μm or greater, or 25 μm or greater. In some examples, the thickness may be 30 μm or less, 25 μm or less, 20 μm or less, 18 μm or less, 16 μm or less, 14 μm or less, 12 μm or less, 10 μm or less, or 5 μm or less. In some examples, the thickness may be 1 μm to 30 μm, 5 μm to 20 μm, or 10 μm to 20 μm.

The passivation coating 230 has a thickness 233. In some examples the thickness of the passivation coating may be one atomic layer (i.e., one monolayer) or greater, 1 nm or greater, 2 nm or greater, 4 nm or greater, 6 nm or greater, 8 nm or greater, 10 nm or greater, or 15 nm or greater, 50 nm or greater, 100 nm or greater, or 250 nm or greater. In some examples the thickness of the passivation coating may be 500 nm or less, 250 nm or less, 100 nm or less, 50 nm or less 20 nm or less, 15 nm or less, 10 nm or less, 8 nm or less, 6 nm or less, 4 nm or less, or 2 nm or less. In some examples the thickness of the passivation coating may be 1 nm to 500 nm, 1 nm to 250 nm, 1 nm to 100 nm, 1 nm to 50 nm, 1 nm to 20 nm, 1 nm to 15 nm, 1 nm to 10 nm, 1 nm to 8 nm, 1 nm to 6 nm, 1 nm to 4 nm, or 1 nm to 2 nm. In some examples the thickness of the passivation coating may be 2 nm to 500 nm, 2 nm to 250 nm, 2 nm to 100 nm, 2 nm to 50 nm, 2 nm to 20 nm, 2 to 15 nm, 2 nm to 10 nm, 2 nm to 8 nm, 2 nm to 6 nm, or 2 nm to 4 nm. In some examples the thickness of the passivation coating may be 4 nm to 500 nm, 4 nm to 250 nm, 4 nm to 100 nm, 4 nm to 50 nm, 4 nm to 20 nm, 4 to 15 nm, 4 nm to 10 nm, 4 nm to 8 nm, or 4 nm to 6 nm. In some examples the thickness of the passivation coating may be 6 nm to 500 nm, 6 nm to 250 nm, 6 nm to 100 nm, 6 nm to 50 nm, 6 nm to 20 nm, 6 to 15 nm, 6 nm to 10 nm, or 6 nm to 8 nm. In some examples the thickness of the passivation coating may be 8 nm to 500 nm, 8 nm to 250 nm, 8 nm to 100 nm, 8 nm to 50 nm, 8 nm to 20 nm, 8 to 15 nm, or 8 nm to 10 nm. In some examples the thickness of the passivation coating may be 10 nm to 500 nm, 10 nm to 250 nm, 10 nm to 100 nm, 10 nm to 50 nm, 10 nm to 20 nm or 10 to 15 nm. In some examples the thickness of the passivation coating may be 15 nm to 500 nm, 15 nm to 250 nm, 50 nm to 100 nm, 15 nm to 20 nm. In some examples the thickness of the passivation coating may be 50 nm to 500 nm, 100 nm to 500 nm, or 250 nm to 500 nm. The thickness of the passivation coating may be measured, for example, by taking a cross section of the current collector and using transmission electron microscopy (TEM) to measure the width of the passivation coating.

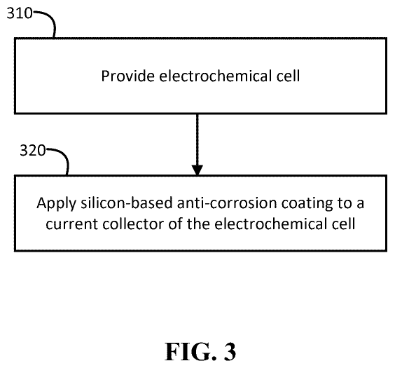

The present disclosure describes methods of making the current collectors with a passivation coating according to examples described herein. A flow diagram of an example method is shown in FIG. 3. The method includes providing 310 an electrochemical cell comprising a positive electrode comprising a first current collector and a negative electrode comprising a second current collector.

A silicon-based anti-corrosion coating is applied 320 to at least partially coat the first current collector. The thickness of the silicon-based anti-corrosion coating may be chosen based on desired electrical properties of the battery. For example, in general, a greater thickness of the anti-corrosion coating achieves greater protection from corrosion but may negatively impact other electrical properties of the device. The thickness may be chosen to balance corrosion protection and desired electrical properties.

According to various examples, the silicon-based anti-corrosion coating may be applied to the entire surface of one or both of the current collectors. In other examples, the silicon-based anti-corrosion coating is only applied to a portion of one or both of the current collectors. In some examples, the silicon-based anti-corrosion coating is applied at a thickness that varies along the surface of one or both of the current collectors. According to various examples, the silicon-based anti-corrosion coating is molecularly bound to the surface of the current collector.

The silicon-based anti-corrosion coating includes a mixture of molecules with a functional silane group on one end. For example, the silicon-based anti-corrosion coating comprises one or more of APTES ((3-Aminopropyl) triethoxysilane) and GPTMS ((3-Glycidyloxypropyl) trimethoxysilane). According to some configurations, the silicon-based anti-corrosion coating is provided with a liquid carrier. The liquid carrier may be any suitable carrier such as water and/or any organic solvent or combination of organic solvents, for example.

The silicon-based anti-corrosion coating composition described herein may be applied to the current collector using any suitable technique, such as, for example, brushing, spraying, spin coating, roll coating, curtain coating, dipping, gravure coating, vapor deposition (for example, exposure to vapor containing HMDS), exposure to pure APTES, and/or the like. As an example, spin coating involves applying an excess amount of a liquid coating solutions or dispersions on a substrate and rotating the substrate at speeds high enough to remove excess material and disperse the remaining material into a thin and uniform. Dip-coating may involve submerging the material into a passivation mixture.

In some examples, contacting the bulk material with the passivation mixture may be done at a passivation temperature. The elevated temperature may facilitate and/or increase the rate of the passivation reactions. In some such examples where the passivation mixture includes a liquid carrier, the mixture may be preheated to a temperature and then contacted with the bulk material. In other such examples, the mixture may be contacted with the bulk material and then the whole system exposed to an elevated temperature. In yet other examples, the mixture may be preheated to a temperature and then contacted with the bulk material and the whole system may be exposed to an elevated temperature.

In some examples, the passivation temperature may be 50° C. or greater, 70° C. or greater, 90° C. or greater, 100° C. or greater, 120° C. or greater, 140° C. or greater, or 160° C. or greater. In some examples, the passivation temperature may be 200° C. or less, 160° C. or less, 140° C. or less, 120° C. or less, 100° C. or less, 90° C. or less, or 70° C. or less. In some examples, the passivation temperature may be 50° C. to 200° C., 50° C. to 160° C., 50° C. to 140° C., 50° C. to 120° C., 50° C. to 100° C., 50° C. to 90° C., or 50° C. to 70° C. In some examples, the passivation temperature may be 70° C. to 200° C., 70° C. to 160° C., 70° C. to 140° C., 70° C. to 120° C., 70° C. to 100° C., or 70° C. In some examples, the passivation temperature may be 90° C. to 200° C., 90° C. to 160° C., 90° C. to 140° C., 90° C. to 120° C., or 90° C. to 100° C. In some examples, the passivation temperature may be 100° C. to 200° C., 100° C. to 160° C., 100° C. to 140° C., or 100° C. to 120° C. In some examples, the passivation temperature may be 120° C. to 200° C., 120° C. to 160° C., or 120° C. to 140° C. In some examples, the passivation temperature may be 140° C. to 200° C. or 140° C. to 160° C. In some examples, the passivation temperature may be 160° C. to 200° C.

In some examples, when employed in a battery that is subjected to elevated temperatures, the current collectors of the present disclosure are corrosion resistant. The amount of current collector corrosion can directly be ascertained through measuring the thickness and/or the mass of an unused current collector and its used current collector counterpart. Additionally, visual observations made with an unaided eye can be used to characterize current collector corrosion. For example, a current collector that is correct may result in the active material (anode active material or cathode active material) flaking off the current collector. An unused current collector is a current collector that has not yet been inserted into a battery. A used current collector is a current collector that has been used in a battery that has been subjected to a given set of conditions. It is understood that the term “unused counterpart” refers to a used current collector in its unused state. It is understood that the term “used counterpart” refers to an unused current collector in its used state.

The amount of current collector corrosion can be measured indirectly as the change in capacity of the battery in which the current collector is used. The change in capacity of the battery is the difference in the capacity of the battery prior to exposure to a given set of conditions and the capacity of the battery after exposure to the given set of conditions.

In some examples, the batteries (that include a current collector of the present discourse) of the present disclosure retain at least a major portion of their capacity as compared to the same battery prior to any exposure to an elevated temperature after repeated cycles. For the sake of clarity of the present disclosure, the term “cycle” refers to combination of one electrochemical cycle and one thermal cycle. In practice, the battery (with the current collector included within the battery) may be subjected to multiple electrochemical cycles prior to a single thermal cycle and vice versa. An electrochemical cycle includes discharging the battery to first state of charge (SOC) and charging the same battery to a second SOC. An electrochemical cycle may include charging the battery to an SOC of 50% or greater, 75% or greater, 80% or greater, 90% or greater, or 95% or greater, and up to 100%. An electrochemical cycle may include discharging the battery to an SOC of 100% or less, 95% or less, 90% or less, 75% or less, 50% or less, 25% or less, or 10% or less, and down to 0%. During a thermal cycle, the battery is exposed to conditions that include an elevated temperature for an exposure time. Sequential cycles may include different charging and discharging SOCs, different elevated temperature for the same and/or different exposure times or the same elevated temperature for the same and/or different exposure time. In some examples, an electrochemical cycle and thermal cycle may overlap in that the exposure to an elevated temperature may occur during use (during the electrochemical cycle).

According to an example, the battery retains 50% or more (e.g., 50% to 100%), 80% or more (e.g., 80% to 100%), 90% or more (e.g., 90% to 100%), 95% or more (e.g., 95% to 100%), or 98% or more (e.g., 98% to 100%) of its capacity after exposure to a plurality of thermal cycles. According to an example, the used current collector retains 50% or more (e.g., 50% to 100%), 80% or more (e.g., 80% to 100%), 90% or more (e.g., 90% to 100%), 95% or more (e.g., 95% to 100%), or 98% or more (e.g., 98% to 100%) of the mass of the unused current collector after exposure to a plurality of thermal cycles. According to an example, the used current collector retains 50% or more (e.g., 50% to 100%), 80% or more (e.g., 80% to 100%), 90% or more (e.g., 90% to 100%), 95% or more (e.g., 95% to 100%), or 98% or more (e.g., 98% to 100%) of the thickness of the unused current collector after exposure to a plurality of thermal cycles. The change in thickness of a current collector may be measured, for example, by comparing x-ray images (e.g., computerized tomography scan images) of the unused current collector and its used counterpart. A thermal cycle exposes the battery to elevated temperature conditions. The elevated temperature conditions of a thermal cycle may include exposure to an elevated temperature of 100° C. or greater, 121° C. or greater, 135° C. or greater, or 140° C. or greater, and up to 200° C. (e.g., 100° C., 121° C., 135° C., 140° C., 100° C. to 200° C., 100° C. to 121° C., 100° C. to 135° C., or 135° C. to 200° C.) for a time period of 1 minute (min) or greater, 4 min or greater, 12 min or greater, 18 min or greater, 20 min or greater, 30 min or greater, 90 min or greater, 120 min or greater, or 180 min or greater, and up to 360 min (e.g., 1 min to 360 min, 4 min to 360 min, 4 min to 180 min, 12 min to 120 min, 12 min to 18 min, 18 min to 30 min, 18 min to 90 min, 18 min to 120 min, 18 min to 180 min, 20 min to 90 min, 20 min to 30 min, or 30 min to 90 min). In some examples, the plurality of thermal cycles is 4 or more, 5 or more, 10 or more, 50 or more, 100 or more, 200 or more, or 300 or more, and up to 500 thermal cycles (e.g., 5 to 500, 5 to 300, 5 to 200, 5 to 100, 50 to 200, 110 to 200, 100 to 300, or 100 to 500 thermal cycles).

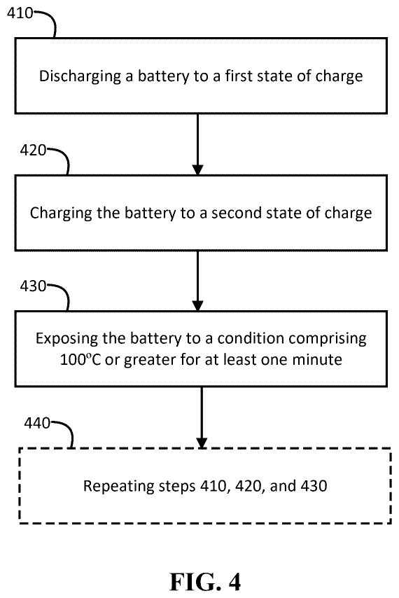

FIG. 4 is a flow diagram outlining a method of use of current collectors of the present disclosure. FIG. 4 includes a full cycle. The method includes discharging the battery to which the current collector is included to a first SOC (step 410). Discharging the battery may be accomplished through the use of a piece of equipment or tool to which it is operable coupled. The battery may be discharged to any SOC (0% to 99%). In a full electrochemical cycle, the battery is discharge to a SOC of 0% to 5%.

The method further includes charging the battery to second SOC (step 420). The battery may be charged to any SOC (e.g., 1% to 100%). In a full electrochemical cycle, the batter is charged to an SOC of 95% to 100%.

The method further includes, exposing the battery to a condition that includes an elevated temperature of 100° C. or greater for at least 1 min. Completion of steps 410, 420, and 430 constitutes a single cycle (e.g., a full electrochemical cycle and a thermal cycle). In some examples, steps 410, 420, and 430 can be sequentially repeated 440 for at least 5 cycles, at least 10 cycles, at least 50 cycles, at least 100 cycles, at least 200 cycles, at least 300 cycles, and up to 500 cycles.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to examples of the disclosure that may afford certain benefits, under certain circumstances. However, other examples may also be preferred, under the same or other circumstances. Furthermore, the recitation of one or more preferred examples does not imply that other examples are not useful and is not intended to exclude other examples from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations, and variations of the disclosed examples incorporating the spirit and substance of the inventive technology may occur to persons skilled in the art, the inventive technology should be construed to include everything within the scope of the appended claims and their equivalents.

What is claimed is:

1. An electrochemical cell comprising:
a positive electrode comprising a first current collector and a first active material;
a negative electrode comprising a second current collector and a second active material;
a separator disposed between the positive electrode and the negative electrode; and
a silicon-based anti-corrosion coating configured to at least partially coat one or both of the first current collector and the second current collector.

2. The electrochemical cell of claim 1, wherein the silicon-based anti-corrosion coating comprises molecules with a functional silane group on one end.

3. The electrochemical cell of claim 1, wherein the silicon-based anti-corrosion coating comprises one or more of APTES ((3-Aminopropyl) triethoxysilane), hexamethyldisilane (HMDS), Spin-on-Glass, and GPTMS ((3-Glycidyloxypropyl) trimethoxysilane).

4. The electrochemical cell of claim 1, wherein the first current collector comprises aluminum.

5. The electrochemical cell of claim 1, wherein the first current collector comprises a metal and the silicon-based anti-corrosion coating is configured to prevent oxidation of the metal.

6. The electrochemical cell of claim 1, wherein the silicon-based anti-corrosion coating comprises one or more of a monolayer and a surface treatment.

7. The electrochemical cell of claim 1, wherein the silicon-based anti-corrosion coating is molecularly bound to a surface of the first current collector.

8. The electrochemical cell of claim 1, wherein a thickness of the silicon-based anti-corrosion coating is in a range of about a monolayer to about 10 μm.

9. The electrochemical cell of claim 1, wherein the silicon-based anti-corrosion coating has a thickness in a range of about a monolayer to about 1 μm.

10. The electrochemical cell of claim 1, wherein a thickness of the silicon-based anti-corrosion coating varies along a surface of the first current collector.

11. The electrochemical cell of claim 1, wherein, after exposure to conditions comprising a temperature in a range of 100° C. to about 170° C., the electrochemical cell retains a capacity of at least 80% of the capacity of an electrochemical that has not been subjected to such conditions.

12. The electrochemical cell of claim 1, wherein the electrochemical cell is a lithium ion battery.

13. The electrochemical cell of claim 1, wherein the silicon-based anti-corrosion coating is configured to provide corrosion resistance at temperatures in a range of about 100° C. to about 170° C.

14. The electrochemical cell of claim 1, wherein the electrochemical cell further comprises an electrolyte, the electrolyte comprising a halogen containing salt, wherein the halogen is fluorine or chlorine.

15. The electrochemical cell of claim 14, wherein the halogen containing salt comprises lithium bis(trifluoromethanesulfonimide) (LiTFSI); lithium difluoro(oxalato)borate (LiDFOB); lithium bis(pentafluoroethyl sulfonyl)imide (LiBETI); lithium bis(fluorosulfonyl)imide (LiFSI), lithium difluoro(oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dicyano-pentafluoroethyl-imidazole; or combinations thereof.

16. A method, comprising:
providing an electrochemical cell comprising a positive electrode comprising a first current collector and a negative electrode comprising a second current collector; and
applying a silicon-based anti-corrosion coating configured to at least partially coat one or both of the first current collector and the second current collector.

17. The method of claim 16, wherein applying the silicon-based anti-corrosion coating comprises one or both of spin coating the silicon-based anti-corrosion coating, dip-coating the silicon-based anti-corrosion coating, and vapor deposition of the silicon-based anti-corrosion coating.

18. The method of any of claim 16, wherein, after exposure to conditions comprising a temperature in a range of 100° C. to about 170° C., the electrochemical cell retains a capacity of at least 80% of the capacity of an electrochemical that has not been subjected to such conditions.

19. The method of any of claim 16, wherein the silicon-based anti-corrosion coating is configured to provide corrosion resistance at temperatures in a range of about 100° C. to about 170° C.

20. A lithium ion battery, comprising:
a positive electrode comprising a first current collector and a first active material;
a negative electrode comprising a second current collector and a second active material;
a separator disposed between the positive electrode and the negative electrode; and
an anti-corrosion coating comprising configured to at least partially coat the one or both of the first current collector and the second current collector, the anti-corrosion coating comprising molecules with a functional silane group on one end.
